(19) United States
(12) Patent Application Publication
(10) Pub. No.: US 2013/0231062 A1
(43) Pub. Date: Sep. 5, 2013

(54) Electromagnetic Noise Evaluation System, Electromagnetic Environment Evaluation System And Program

(71) Applicants: Yasuo Yahagi, Shinjuku (JP); Satoshi Nakamura, Yokohama (JP); Tatsuji Noma, Yokohama (JP)

(72) Inventors: Yasuo Yahagi, Shinjuku (JP); Satoshi Nakamura, Yokohama (JP); Tatsuji Noma, Yokohama (JP)

(73) Assignee: Hitachi, Ltd., Chiyoda-ku, Tokyo (JP)

(21) Appl. No.: 13/883,792

(22) PCT Filed: Oct. 14, 2011
(86) PCT No.: PCT/JP2011/073668

§ 371 Date: May 7, 2013

(30) Foreign Application Priority Data
Nov. 8, 2010 (JP) 2010-249840

(51) Int. Cl. H04B 17/00

(52) U.S. Cl. CPC H04B 17/0037
USPC 455/67.13

(57) ABSTRACT

There are cases where electromagnetic waves radiated from a device influence another device, whereby the operation of the other device becomes unstable. The present invention provides a system having a detailed database of a device that radiates electromagnetic waves, so that a spatial distribution of electromagnetic waves radiated from an electric/electronic device can be computed, and the influence of the electromagnetic waves on another electric/electronic device can be evaluated.

### TECHNICAL FIELD

The present invention relates to a system that evaluates the influence of electromagnetic waves coming from an electromagnetic noise source, and a system that evaluates the influence of electromagnetic interference between electromagnetic noise coming from an electromagnetic noise source and radio waves that the own device transmits.

### BACKGROUND ART

Conventionally, identification numbers of cargos, and operation information or control information on devices in plants have been directly input to terminals by humans, and transmitted to other terminals via wires.

In recent years, however, wireless devices have been increasingly used to avoid the complexity of wire (i.e., cable) connection. Wireless devices are increasingly used not only in an environment of a site where cargos are handled, in plants, and the like, but also in an environment of an office and the like.

Meanwhile, in order for a wireless device to be effectively used, the stability of the wireless connection is required. In an environment of a site where cargos are handled, in plants, and the like and further, in an environment of an office and the like, housings of devices, file cabinets, pillars of the building, and other metal structures are present. Radio waves transmitted from a wireless device are reflected by the metals or diffracted by the structures. Therefore, there usually exists a plurality of wireless paths from a transmitter to a receiver.

In addition, devices other than wireless device, like a computer and a motor, used in such an environment also radiate electromagnetic waves. Such electromagnetic waves often become electromagnetic noise on the wireless device. Therefore, there is a possibility that the stability of the wireless communication may be degraded.

Meanwhile, there are also cases where radio waves transmitted from a wireless device act as electromagnetic noise on a wired device, whereby the operation of the wired device becomes unstable. Further, not only for a wireless device, but also for wired devices, there are cases where due to electromagnetic noise radiated from one device, the operation of the other device becomes unstable.

### CITATION LIST

### Patent Literature

Patent Literature 1: JP Patent Publication No. 2002-353873 A

Patent Literature 2: JP Patent Publication No. 2002-271275 A

Patent Literature 3: JP Patent Publication No. 10-62468 A

### SUMMARY OF INVENTION

### Technical Problem

As described above, in many use environments, various electromagnetic waves that may possibly act as electromagnetic noise on other devices are flying. Therefore, nowadays, there is an increasing demand for stable operations of electronic/electric devices.

Patent Literature 1 describes simulating a radio wave propagation analysis using an antenna model, which is obtained by modeling the antenna characteristics including the influence of humans and objects in advance, and an ambient environment model. It should be noted that an analysis that takes into consideration the influence of humans and objects can also be performed using a ray-tracing method (an imaging method or a ray launching method). Patent Literature 1 describes that by performing a radio wave propagation analysis for only a movement path of a wireless communication device attached to a human, it is possible to reduce the analysis time and save the memory, and also describes that by selecting a communication failure section from the results of communication characteristics displayed on a simulator and displaying a ray that has arrived at the communication failure section, it is possible to visualize the reflection or shielding by which object in the analyzed space is a cause of the communication failure. According to Patent Literature 1, taking a measure in accordance with the visualized cause can improve the communication characteristics.

However, a cause of a communication failure of a communication device is not limited to the reflection or shielding of radio waves transmitted from a transmitter of the communication device. Besides, electromagnetic waves radiated from a device outside the communication device and the like can also be a cause of a communication failure of the communication device.

In particular, when a device that radiates electromagnetic waves is located near the receiver, the influence thereof is quite large, resulting in a communication failure. Further, when the receiver is located away from the transmitter, communication may also fail even if a device that radiates electromagnetic noise is located away from the receiver.

Meanwhile, there are also cases where radio waves transmitted from a wireless device become electromagnetic noise on a wired device or on a device other than a wireless device that is a target communication device, whereby the operation of the device becomes unstable. Further, not only for a wireless device, but also for wired devices or devices other than the wireless device, there are cases where due to electromagnetic noise radiated from one device, the operation of the other device becomes unstable.

By the way, a wireless device has an antenna. Thus, it is clear that the antenna serves as the main entrance for signal radio waves directed to the wireless device (receiver) or other electromagnetic waves that have propagated through the space. However, a wired device or a device other than a wireless device that is a target communication device has no built-in antenna. Therefore, it is impossible to clearly fix a portion that serves as an antenna for radiating electromagnetic waves to the space, or a portion that serves as an entrance for electromagnetic waves that have propagated through the space.

The inventors have conducted concentrated studies about such technical problem and arrived at an invention described below.

### Solution to Problem

In the present invention, first, an information database that has stored therein radiation information on a device that radiates electromagnetic waves is used to compute a spatial distribution of electromagnetic waves radiated from the electric/electronic device. Next, in the present invention, computation is performed on a range of a region where, for when an electric/electronic device (a non-wireless device) or a wireless device is arranged at each position in the used area, the data error rate of the device becomes large due to the influence of electromagnetic waves coming from the outside.

### Advantageous Effects of Invention

According to the present invention, a simulator that takes into consideration the influence of electromagnetic noise radiated from devices can be provided. Other problems, configurations, and advantageous effects will become apparent from the following description of embodiments.

### BRIEF DESCRIPTION OF DRAWINGS

FIG. 1 is a diagram showing an exemplary overall configuration of an electromagnetic noise evaluation system according to Embodiment 1;

FIG. 2 is a diagram showing an exemplary overall configuration of an electromagnetic noise evaluation system according to Embodiment 2;

FIG. 3 is a view showing a layout of a manufacturing apparatus in a plant;

FIG. 4 is a diagram showing the frequency spectrum of electromagnetic waves radiated from a welding machine;

FIG. 5 is a diagram showing the time spectrum of electromagnetic waves radiated from a welding machine;

FIG. 6 is a diagram showing the relationship between a layout of a manufacturing apparatus and the installation position of a wireless device;

FIG. 7 is a diagram showing the relationship among a layout of a manufacturing apparatus, the installation position of a wireless device, and a region where wireless communication fails;

FIG. 8 is a diagram showing the relationship among a layout of an office, the installation position of an entrance/exist management system, and the planned installation position of an air cleaner;

FIG. 9 is a diagram showing the frequency spectrum of electromagnetic waves radiated from an air cleaner that is planned to be installed in an office;

FIG. 10 is a view showing a layout of an office and a region where an entrance/exist management system does not operate normally.

### DESCRIPTION OF EMBODIMENTS

Hereinafter, embodiments that are adapted to the implementation of the present invention will be described with reference to the drawings.

### Embodiment 1

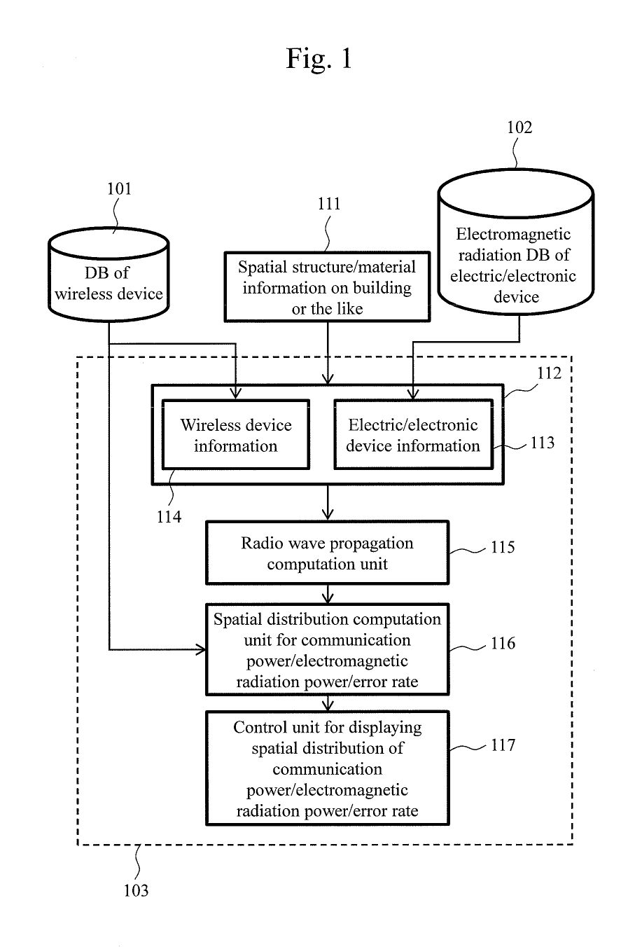

FIG. 1 shows a schematic configuration of an electromagnetic noise evaluation system (a wireless environment evaluation system) in accordance with Embodiment 1. This embodiment will describe a system that evaluates the influence of electromagnetic waves radiated from an electric/electronic device on a wireless device. Hereinafter, a case where a wireless device is used in a building will be described.

The system includes a database 101 of a wireless device, an electromagnetic radiation database 102 of an electric/electronic device, and a computer 103. The database 101 of the wireless device and the electromagnetic radiation database 102 of the electric/electronic device may be built in the computer 103 or be connected thereto via a network.

The database 101 of the wireless device holds the operating conditions of the wireless device. The operating conditions include a modulation scheme, a carrier frequency, an encoding scheme, data transmission/reception durations, the minimum received power, and the ratio of the received signal power to the electromagnetic wave power, for a data error rate, of the wireless device, information about other wireless devices, and the like. The wireless device is not specifically limited. For example, the wireless device may be an in-vehicle radio, a digital terrestrial broadcast receiver, a wireless LAN terminal, a sensor network, or the like.

The electromagnetic radiation database 102 of the electric/electronic device has stored therein radiation information on the electric/electronic device that radiates electromagnetic waves. The radiation information includes information about the frequency spectrum, the radiation angle, the electromagnetic wave generation duration, and the frequency of electromagnetic wave generations of the radiated electromagnetic waves, and the installation orientation of the electric/electronic device. An electric/electronic device that becomes an electromagnetic wave generation source is not specifically limited. For example, the electric/electronic device may be a manufacturing robot, a crane, or the like.

The computer 103 includes a storage unit 112, a radio wave propagation computation unit 115, a spatial distribution computation unit 116 for the communication power/electromagnetic radiation power/error rate, and a control unit 117 for displaying a spatial distribution of the communication power/electromagnetic radiation power/error rate. In this embodiment, the spatial distribution computation unit 116 for the communication power/electromagnetic radiation power/error rate, and the control unit 117 for displaying a spatial distribution of the communication power/electromagnetic radiation power/error rate are implemented as programs that are executed on the computer 103. Such units may also be implemented as special electronic boards or cards.

The storage unit 112 receives spatial structure/material information 111 on a building or the like that exists in the space to be evaluated, from outside of the system. Examples of the spatial structure/material information 111 on a building or the like include, for example, the three-dimensional structure of a structural body, the chemical composition of the structural body, a reflection coefficient of electromagnetic waves, an absorption coefficient of electromagnetic waves, and the like. The spatial structure/material information 111 on a building or the like may be input via a GUI or input from external storage memory or from a database (not shown) that resides on the network.

The storage unit 112 receives information 113 on an electric/electronic device installed in the space to be evaluated (electric/electronic device information), and information 114 on a wireless device to be used (wireless device information), from associated databases. As shown, the electric/electronic device information 113 corporates with the electromagnetic radiation database 102 of the electric/electronic device, and the wireless device information 114 corporates with the database 101 of the wireless device. The wireless device information 114 may be selectively input to the storage unit 112 from the database 101 of the wireless device. The electric/electronic device information 113 includes information about the installation orientation of the electric/electronic device.

The radio wave propagation computation unit 115 computes the propagation paths of radio waves transmitted from the wireless device and radio waves radiated from the electric/electronic device that radiates electromagnetic waves. For the computation, the radio wave propagation computation unit 115 acquires three-dimensional structure information on the building from the spatial structure/material information 111 on the building. In addition, the radio wave propagation computation unit 115 acquires from the electric/electronic device information 113 three-dimensional position information on the electric/electronic device that radiates electromagnetic waves. Further, the radio wave propagation computation unit 115 acquires three-dimensional position information on the wireless device from the wireless device information 114. The radio wave propagation computation unit 115 computes the propagation paths on the basis of such three-dimensional structure information and three-dimensional position information.

In this embodiment, a ray-tracing method is used for the computation of the propagation paths, for example. Note that the problems of reflections or scattering due to structures can be solved precisely by strictly applying a Maxwell's equation. However, such a solving method is time-consuming in terms of computation, and thus is not realistic. Meanwhile, a ray-tracing method represents an electromagnetic wave plane as simple points. Therefore, such points can be approximated to a simple geometric equation, and can be computed within a realistic time.

The spatial distribution computation unit 116 for the communication power/electromagnetic radiation power/error rate computes a distribution of the power (received signal power) at each position (three-dimensional) in the space to be evaluated on the basis of the computed propagation paths. Next, the spatial distribution computation unit 116 for the communication power/electromagnetic radiation power/error rate computes the ratio of the received signal power to the electromagnetic wave power for each position (three-dimensional) in the three-dimensional space. The electromagnetic wave power herein is the power of electromagnetic waves used for the wireless device to communicate. That is, the electromagnetic wave power is the communication power. Next, the spatial distribution computation unit 116 for the communication power/electromagnetic radiation power/error rate extracts from the database 101 of the wireless device a data error rate corresponding to the ratio of the received signal power to the electromagnetic wave power computed for each position in the space. Note that when the data error rate is already read into the storage unit 112 as the wireless device information 114, the data error rate is read from the storage unit 112.

The control unit 117 for displaying a spatial distribution of the communication power/electromagnetic radiation power/error rate displays the data error rate computed for each position in the space to be evaluated on an operation screen (not shown) as distribution information associated with the space layout (three-dimensional) to be evaluated. Needless to say, it is also possible to display a result of comparison between the computed data error rate and a preset threshold on the operation screen (not shown) as distribution information associated with the space layout (three-dimensional) to be evaluated. Note that the output destination of the distribution information on the data error rate may be a printer or a communication line. The data error rate may be displayed either in binary value representation (in the presence of one threshold) or multi-value representation (in the presence of a plurality of thresholds). In addition, a difference in the data error rate may be represented using the luminance, display color, numerical value, or the like.

According to the electromagnetic noise evaluation system in accordance with this embodiment, it is possible to evaluate in advance the degree of electromagnetic interference generated between electromagnetic waves radiated from the existing electric/electronic device and electromagnetic waves of a newly installed wireless device as the difference in the data error rate. Thus, it is possible to not only know whether a wireless device can be arranged in the space to be evaluated but also arrange the wireless device at an optimal position. Further, the electromagnetic noise evaluation system in accordance with the embodiment can realize the same effect based on the realistic computation amount. Furthermore, as described below, the degree of electromagnetic interference can be checked as a distribution map of the data error rates. Therefore, a user can easily determine whether a wireless device can be newly installed or the influence thereof. That is, a user-friendly system can be implemented.

### Embodiment 2

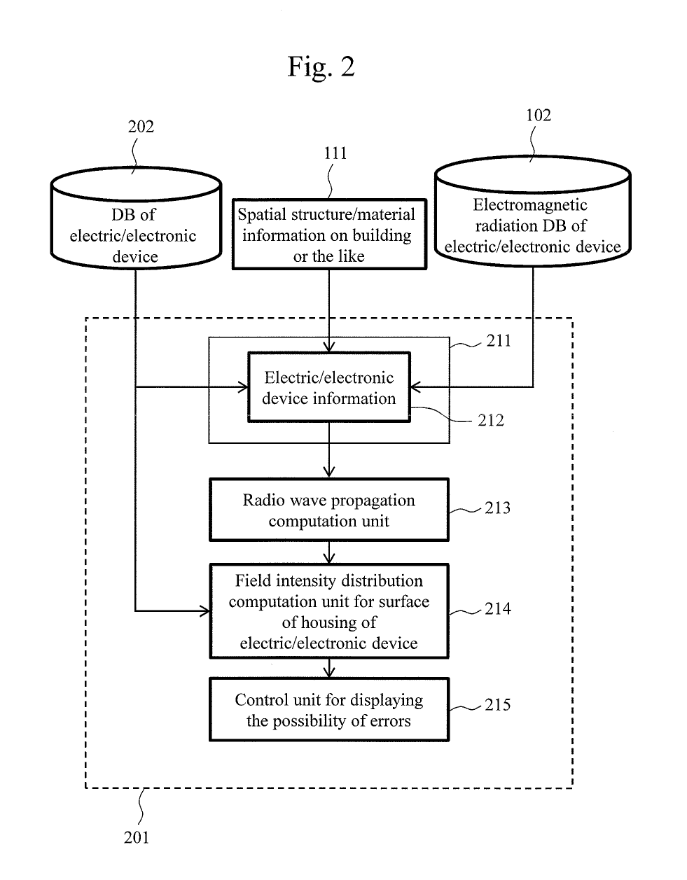

FIG. 2 is a diagram showing an exemplary overall configuration of another electromagnetic noise evaluation system. This embodiment will describe a system that evaluates the influence of electromagnetic waves radiated from an electric/electronic device on another electric/electronic device. That is, a system that evaluates the influence of electromagnetic interference between electric/electronic devices having no wireless function will be described. Note that in FIG. 2, portions corresponding to those in FIG. 1 are denoted by identical reference numerals.

The system includes a database 202 of an electric/electronic device, an electromagnetic radiation database 102 of an electric/electronic device, and a computer 201.

The database 202 of the electric/electronic device has stored therein the operating conditions and electromagnetic wave sensing properties (antenna properties) of the electric/electronic device. The electromagnetic wave sensing properties include an antenna model and a data error rate corresponding to the received electromagnetic wave power. The electric/electronic device is not specifically limited.

As described above, the electric/electronic devices in accordance with this embodiment have no antennae unlike a wireless device. Therefore, it is impossible to clearly fix a portion of a region that serves as an antenna that radiates electromagnetic waves to the space and an entrance for electromagnetic waves that have propagated through the space. Therefore, in this embodiment, the database 202 of the electric/electronic device has stored therein an antenna model of the electric/electronic device without a built-in antenna.

For example, a laptop computer has a number of slots with a dimension of about 1 cm within a volume of about 30 cm×20 cm×2 cm. In such a case, the slots are assumed to function as antennae and are registered in the database 202 of the electric/electronic device. Note that the antenna model is created using a known method on the basis of information on the housing configuration, cables in the housing, and the operating conditions of the electric/electronic device. The antenna model is created not only for an electric/electronic device that receives electromagnetic waves from the outside but also for an electric/electronic device that becomes an electromagnetic wave generation source.

The computer 201 includes a storage unit 211, a radio wave propagation computation unit 213, a field intensity distribution computation unit 214 for the surface of a housing of an electric/electronic device, and a control unit 215 for displaying the possibility of errors. In this embodiment, the storage unit 211 has stored therein electric/electronic device information 212. The electric/electronic device information 212 is provided with spatial structure/material information 111 on a building or the like that exists in the space to be evaluated, from outside of the system. Radiation information on an electric/electronic device that is an electromagnetic wave generation source is read into the storage unit 211 from the electromagnetic radiation database 102 of the electric/electronic device.

The sensing properties and the operating conditions of an electric/electronic device for which the influence of electromagnetic interference is to be evaluated is read into the storage unit 211 from the database 202 of the electric/electronic device. The electric/electronic device information 212 includes information about the installation orientation of the electric/electronic device that is the electromagnetic wave generation source.

The radio wave propagation computation unit 213 computes the propagation path of radio waves radiated from the electric/electronic device that operates as the electromagnetic wave generation source. For the computation, the radio wave propagation computation unit 213 acquires the three-dimensional structure information on the building from the spatial structure/material information 111 on the building or the like. In addition, the radio wave propagation computation unit 213 acquires from the electric/electronic device information 212 the three-dimensional position information on the electric/electronic device that radiates electromagnetic waves. The radio wave propagation computation unit 213 computes the propagation path on the basis of such three-dimensional structure information and three-dimensional position information. In this embodiment also, a ray-tracing method is used for the computation of the propagation path, for example.

The field intensity distribution computation unit 214 for the surface of a casing of an electric/electronic device computes the electromagnetic wave power (received electromagnetic wave power) received at each position (thee-dimensional) in the space to be evaluated. Specifically, the field intensity distribution computation unit 214 computes the field intensity distribution of the surface of a housing of an electric/electronic device (e.g., the surface of a housing of a laptop computer). Then, the field intensity distribution computation unit 214 extracts from the database 202 of the electric/electronic device a data error rate corresponding to the field intensity distribution computed for each position (three-dimensional) in the space. Note that when the data error rate is already read into the storage unit 211 as the electric/electronic device information 212, the data error rate is read from the storage unit 211.

The control unit 215 for displaying the possibility of errors displays the result of comparison between a preset threshold and the data error rate computed for each position in the space to be evaluated on an operation screen (not shown) as the distribution information associated with the space layout (three-dimensional) to be evaluated. The preset threshold is the value of a data error rate that provides a boundary value having influence on the normal operation.

In this embodiment, the control unit 215 for displaying the possibility of errors outputs the result of comparison between the preset threshold and the data error date in association with the space layout, but may also display only the data error rate in association with the space layout as in Embodiment 1.

The output destination of the processing result of the control unit 215 for displaying the possibility of errors may also be a printer or a communication line. The output result may be displayed either in binary value representation (in the presence of one threshold) or multi-value representation (in the presence of a plurality of thresholds). In addition, a difference in the data error rate may be represented using the luminance, display color, numerical value, or the like.

According to the electromagnetic noise evaluation system in accordance with this embodiment, it is possible to evaluate in advance the degree of electromagnetic interference of electromagnetic waves radiated from the existing electric/electronic device on a newly installed electric/electronic device. Thus, it is possible to not only know whether an electric/electronic device can be arranged in the space to be evaluated but also arrange the electric/electronic device at an optimal position. Further, the electromagnetic noise evaluation system in accordance with the embodiment can realize the same effect based on the realistic computation amount. Furthermore, as described below, the degree of electromagnetic interference can be checked as a distribution map of the data error rates. Therefore, a user can easily determine whether an electric/electronic device can be newly installed or the influence thereof. That is, a user-friendly system can be implemented.

### EXAMPLE 1

This example will describe a case where a wireless device is used to acquire the operation information on a manufacturing apparatus in a plant. This example corresponds to Embodiment 1.

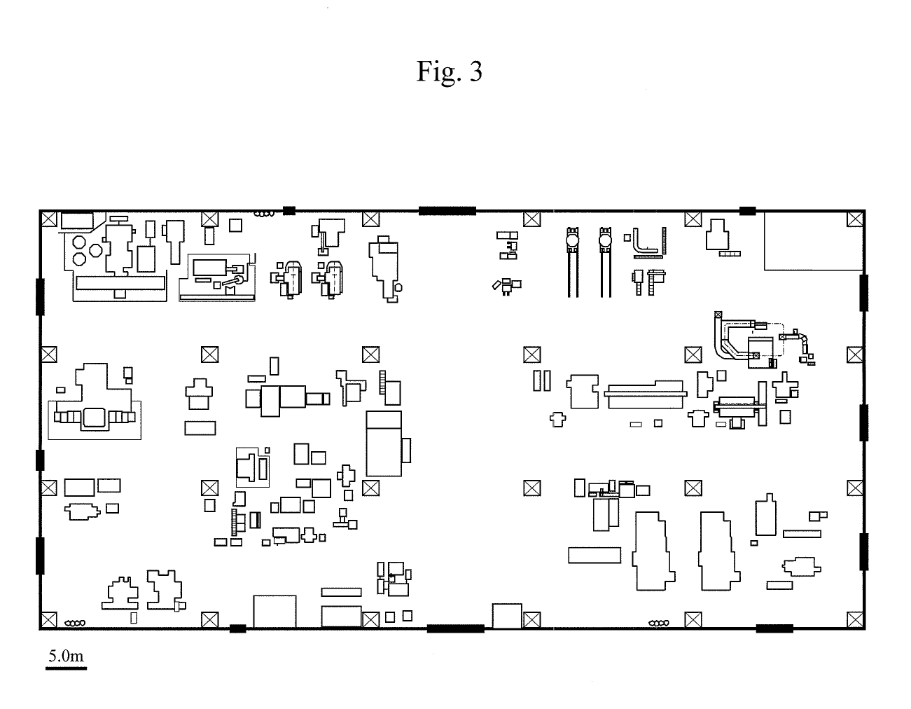

FIG. 3 shows a top layout view of a plant. The dimensions of the building are 100 m (long side), 50 m (short side), and 18 m (height). Pillars and beams are made of steel, and the wall surface is surrounded by steel sheets and window glass. The wall surface has a shutter made of steel, and an entrance door for humans is also made of steel and window glass. A grinding processing machine, an electrical discharge machine, an annealing furnace, a welding machine, and the like are arranged in the plant building. The frequency spectrum of a device that radiates electromagnetic waves and the time spectrum of the radiated electromagnetic waves are stored in the electromagnetic radiation database 102 of the electric/electronic device (FIG. 1).

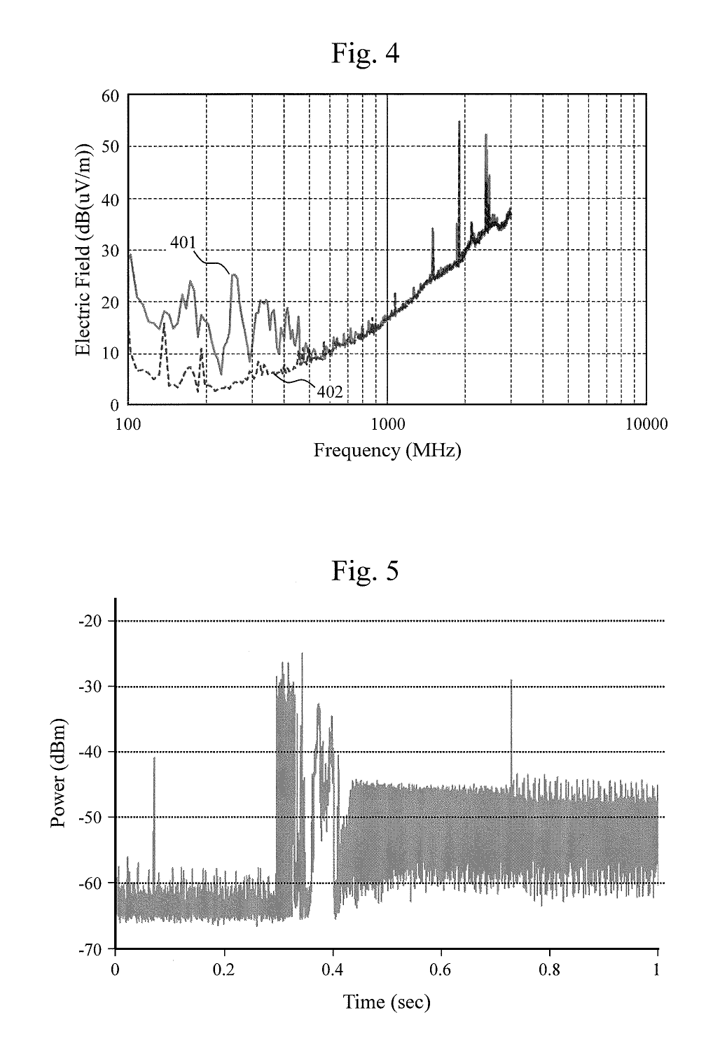

Herein, the welding machine is focused on as an example. FIG. 4 shows a spectrum of electromagnetic waves radiated from the welding machine, and FIG. 5 shows the time spectrum.

The solid line 401 in FIG. 4 is one example of the spectrum of radiated emission from the welding machine obtained with a spectrum analyzer operated in max hold mode. A dashed line 402 in FIG. 4 is a background spectrum acquired while the welding machine is stopping operation. The electromagnetic radiation database 102 of the electric/electronic device has stored therein the results obtained by measuring such spectra around the welding machine as the electromagnetic radiation data. Note that the two types of spectra are acquired for each position where the antenna is moved in the circumferential direction around the welding machine by 10 degrees, for example.

FIG. 5 represents the time spectrum of the welding machine acquired by a real-time spectrum analyzer only for one second. This data is also stored in the electromagnetic radiation database 102 of the electric/electronic device as the electromagnetic radiation data on the welding machine.

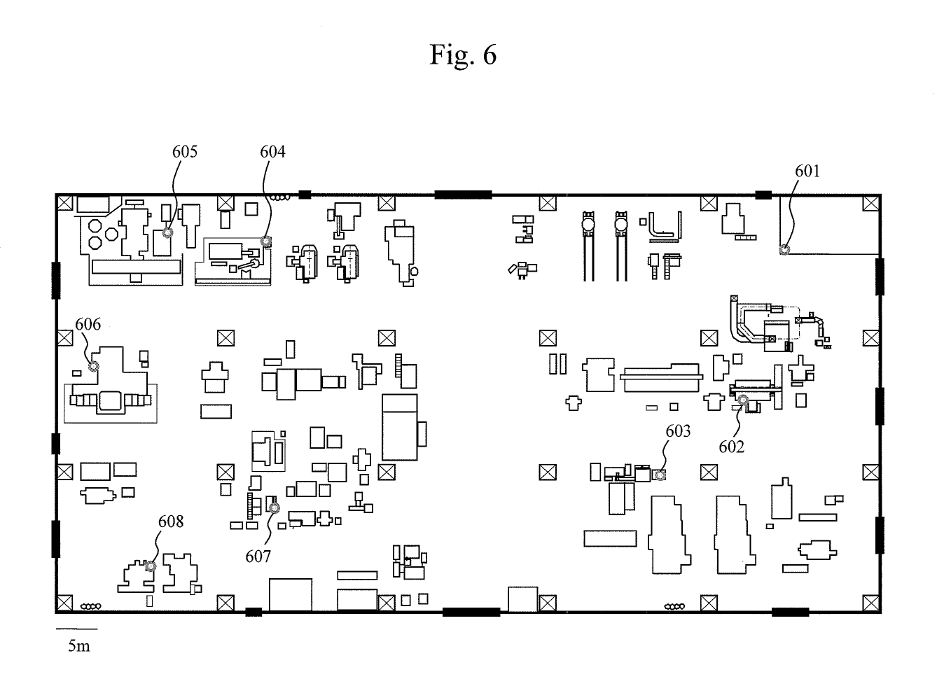

FIG. 6 shows an arrangement example of a wireless device. In this example, a low-power wireless machine that operates in a 429 MHz band is used as the wireless device. The transmission output of the wireless device is assumed to be 10 mW. In addition, binary FSK (Frequency Shift Keying) is used as the modulation scheme of the wireless device.

In FIG. 6, an antenna 601 of a wireless device used as a host is fixed at a position with a height of 2.5 m on the corner of an office. This time, wireless nodes are intended to be arranged on some devices 602 to 608 from which the operating conditions of the production facility devices are to be acquired.

In this example, it was determined that communication fails when the data error rate of wireless communication becomes higher than 1×10⁻⁴, for example. In this example, simulation of radio wave propagation was carried out with the electric/electronic devices in the surrounding in the operating conditions.

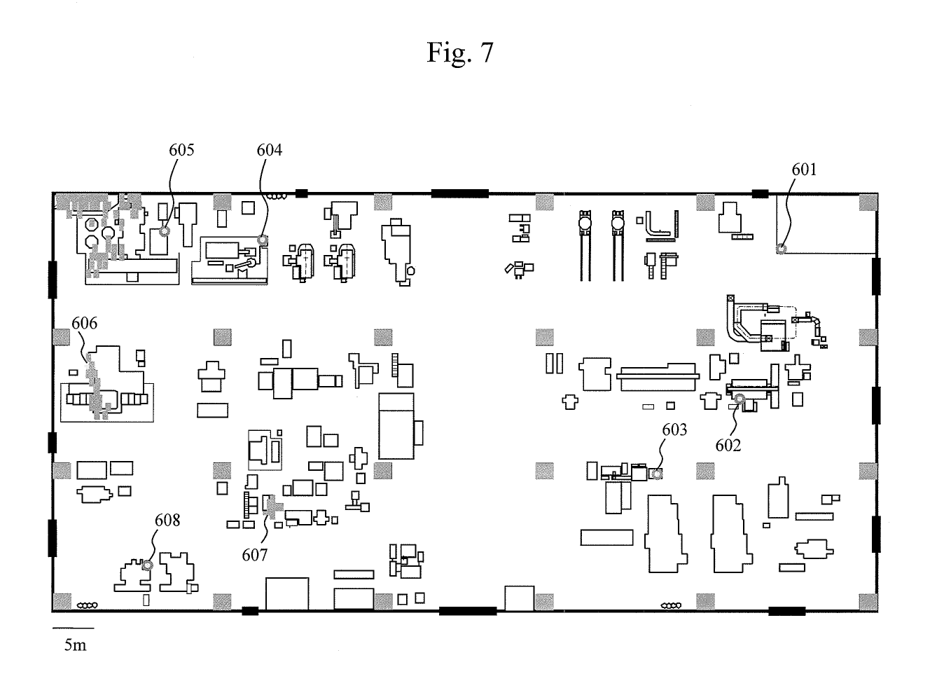

FIG. 7 shows data related to the height of 2.5 m among the results of simulation computed for each height in the plant. In this embodiment, simulation in the height direction is executed in increments of 10 cm, for example. In FIG. 7, a space in which the data error rate is higher than 1×10⁻⁴ is shown by hatching. From FIG. 7, it is found that communication can be performed when a wireless device is installed at almost any place in the plant building. However, it is also found that there exist regions where the data error rate is higher than 1×10⁻⁴ and communication fails, that is, communication is not established. For example, it is found that, around the wireless node 607, a region where communication is not possible is formed in an island shape. Seeing that communication is established in a peripheral region of 1 m or more away from the welding machine, it can be determined that electromagnetic waves radiated from the welding machine disable the wireless communication. Thus, it is found that communication fails when a wireless device is attached to the welding machine.

Note that rectangular hatched regions that are regularly arranged in the longitudinal direction and the lateral direction correspond to the positions where pillars are arranged.

### EXAMPLE 2

This example will describe a case where an electric/electronic device is intended to be newly introduced into an office that has an entrance/exist management system for security purposes. This example corresponds to Embodiment 2.

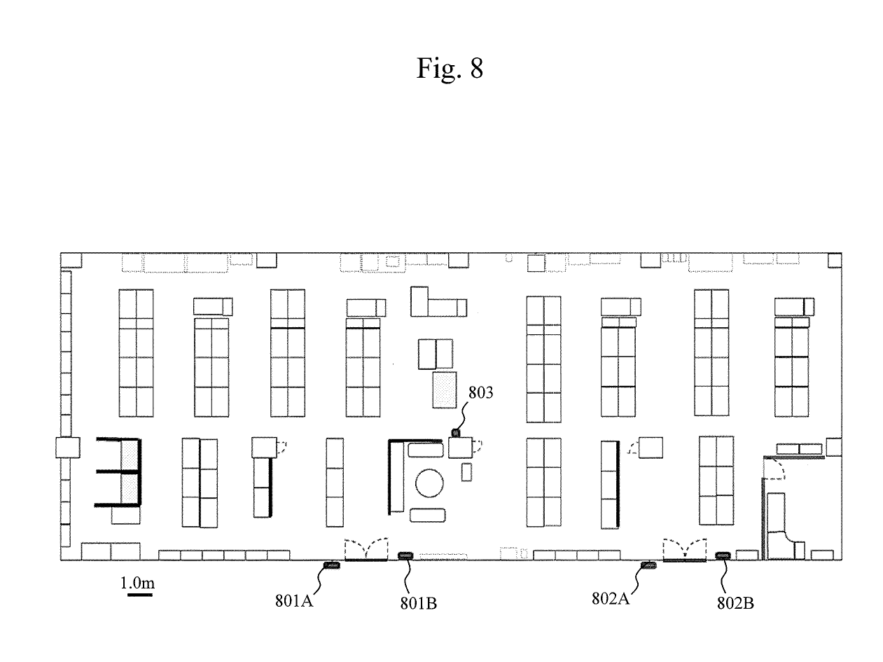

FIG. 8 shows a top layout view of an office. The dimensions of the room are 31 m (long side), 12 m (short side), and 2.65 m (height from the floor to the ceiling).

Herein, a portion indicated by a scale of 1 m is assumed to be the “lower left” of the top layout view. A region above the top side and a region to the right of the right side of the top layout view are outside the building. Thus, aluminum sash windows that partially form the outer wall are arranged on the top side and the right side. The walls of the top side and the right side are made of plasterboards, and have aluminum sash windows at heights in the range of 1 m to 2.65 m.

A region below the bottom side of the top layout view is a corridor, and a region to the left of the left side is an adjoining office room. Two doors are arranged on the wall on the corridor side. Each door is made of steel, and has window glass attached thereto.

In this office, a system is used that utilizes a weak radio wave RFID in a 300 MHz band for entrance/exist management. Note that binary FSK is used for the modulation scheme of this system. In the drawing, reference numerals 801A, 801B, 802A, and 802B are readers. The readers 801A and 802A are adapted for entrance management, and the readers 801B and 802B are adapted for exit management.

In this example, it is assumed that an air cleaner 803 is planned to be installed at a height of 2 m of a pillar that is located in substantially the center of the office. The air cleaner 803 operates at AC 100 V and with a power consumption of 6 W.

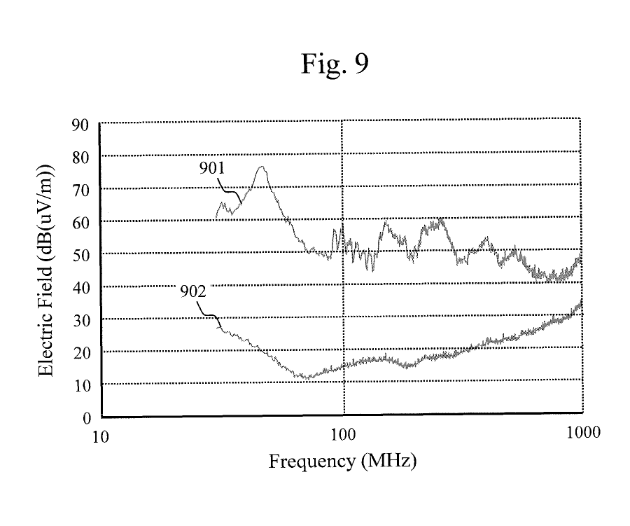

FIG. 9 shows a frequency spectrum of electromagnetic waves radiated from the air cleaner 803, stored in the electromagnetic radiation database 102 of the electric/electronic device. In the drawing, reference numeral 901 denotes the frequency spectrum of electromagnetic waves radiated when the air cleaner is operating, and reference numeral 902 denotes a background spectrum measured when the air cleaner is not operating.

In this example, the entrance/exist management system also defines regions where the data error rate is 1×10⁻⁴, for example, to be non-normal operation regions. In such a case, simulation of radio wave propagation was carried out with the air cleaner 803 in the operating condition.

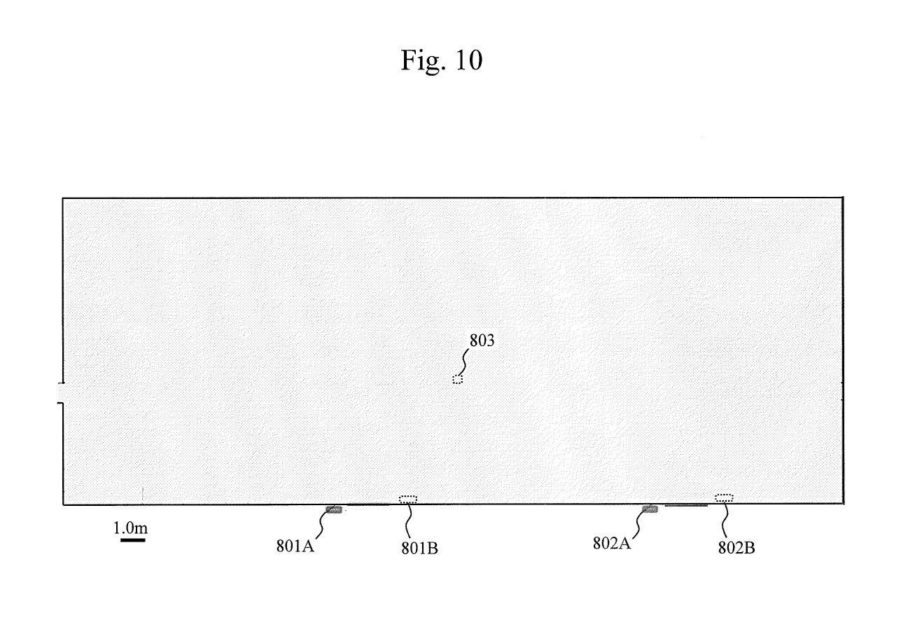

FIG. 10 shows the result about a height of 1.5 m among the result of simulation computed for each height in the office. In FIG. 10 also, a space in which the data error rate is above 1×10⁻⁴ is shown by hatching. From FIG. 10, it is found that reading of the RFID in a 300 MHz band is invalid in the entire region of the office. The readers 801B and 802B arranged in the office are included in this reading invalid region. That is, exist management cannot be performed. This results in a conclusion that the plan to introduce the air cleaner 803 should be stopped.

For typical electric/electronic devices, the upper limit of the radiation intensity of electromagnetic waves is defined by the IEC (International Electrotechnical Comission) standards or CISPR (ComiteInternational Special des Perturbation Radioelectrique) standards. The air cleaner (ozonator) in this example complies with the CISPR14 standards. However, as the ozonator is subjected to self-regulation, it need not necessarily follow the upper limit of the standards. As described above, the electromagnetic noise evaluation system in accordance with the embodiment is advantageous in determining in advance whether a device, for which the upper limit of the radiation intensity of electromagnetic waves is not defined, should be newly introduced.

### CONCLUSION

The aforementioned embodiments and examples have described cases where electromagnetic noise is evaluated indoors. However, the present invention can also be used to evaluate electromagnetic noise outdoors.

The present invention is not limited to the aforementioned embodiments and examples, and includes various variations. For example, although the aforementioned embodiments and examples have been described in detail to clearly illustrate the present invention, the present invention need not include all of the structures described in the embodiments and examples. It is possible to replace a part of a structure of an embodiment or example with a structure of another embodiment or example. In addition, it is also possible to add, to a structure of an embodiment or example, a structure of another embodiment or example. Further, it is also possible to, for a part of a structure of each embodiment or example, add/remove/substitute a structure of another embodiment or example.

Some or all of the aforementioned structures, functions, processing units, processing means, and the like may be implemented by hardware through designing of an integrated circuit, for example. Alternatively, each of the aforementioned structures, functions, and the like may be implemented by software so that a processor analyzes and executes a program that implements each function. Information such as the program that implements each function, tables, and files can be placed on a recording device such as memory, a hard disk, or a SSD (Solid State Drive); or a recording medium such as an IC card, an SD card, or a DVD.

In addition, the control lines and information lines represent those that are considered to be necessary for the description, and do not necessarily represent all control lines and information lines that are necessary for a product. In practice, almost all structures may be considered to be mutually connected.

### REFERENCE SIGNS LIST

101 Database of a wireless device
102 Electromagnetic radiation database of an electric/electronic device
103 Computer
111 Spatial structure/material information on a building or the like
112 Storage unit
113 Electric/electronic device information
114 Wireless device information
115 Radiowave propagation computation unit
116 Spatial distribution computation unit for the communication power/electromagnetic radiation power/error rate
117 Control unit for displaying a spatial distribution of the communication power/electromagnetic radiation power/error rate
201 Computer
202 Database of an electric/electronic device
211 Storage unit
212 Electric/electronic device information
213 Radio wave propagation computation unit
214 Field intensity distribution computation unit for the surface of a housing of an electric/electronic device
215 Control unit for displaying the possibility of errors

1. An electromagnetic noise evaluation system comprising:
a first information database that has stored therein an operating condition and an electromagnetic wave sensing property of a first electric/electronic device and;
a second information database that has stored therein radiation information on at least one second electric/electronic device that radiates electromagnetic waves; and
a control device,
wherein the control device executes
a first process of computing propagation of electromagnetic waves radiated from the second electric/electronic device on the basis of information on a used area of the first electric/electronic device, three-dimensional position information about arrangement of the first electric/electronic device, and three-dimensional position information on the second electric/electronic device,
a second process of computing electromagnetic wave power received at each position in a three-dimensional space in which the first electric/electronic device is arranged,
a third process of extracting from the first information database a data error rate corresponding to the received electromagnetic wave power computed for each position, and
a fourth process of outputting a region where the data error rate is above a desired data error rate in association with each position of the used area.

2. The electromagnetic noise evaluation system according to claim 1, wherein the second information database has data on an antenna model created on the basis of a housing configuration, a cable, and an operating condition of the second electric/electronic device.

3. The electromagnetic noise evaluation system according to claim 1, wherein the second information database has a frequency spectrum, a radiation angle, an electromagnetic wave generation duration, and a frequency of electromagnetic wave generations of radiated electromagnetic waves.

4. The electromagnetic noise evaluation system according to claim 1, wherein the first information database has data on a data error rate corresponding to the received electromagnetic wave power, and an antenna model created on the basis on a housing configuration, a cable, and an operating condition of the first electric/electronic device.

5. The electromagnetic noise evaluation system according to claim 1, wherein information on the used area is a three-dimensional structure of a structural body, a chemical composition of materials of the structural body, a reflection coefficient of electromagnetic waves, and an absorption coefficient of electromagnetic waves.

6. The electromagnetic noise evaluation system according to claim 1, wherein the control device displays, of the used area, a region where the data error rate is above a desired data error rate on a display screen in a manner that distinguishes the region from other regions.

7. A wireless environment evaluation system comprising:
a first information database that has stored therein an operating condition of a wireless device;
a second information database that has stored therein radiation information on at least one electric/electronic device that radiates electromagnetic waves; and
a control device,
wherein the control device executes
a first process of computing propagation of electric waves transmitted from the wireless device and electromagnetic waves radiated from the electric/electronic device on the basis of information on a used area of the wireless device, three-dimensional position information about arrangement of the wireless device, and three-dimensional position information on the electric/electronic device,
a second process of computing a ratio of received signal power to electromagnetic wave power for each position in a three-dimensional space in which the wireless device is arranged,
a third process of extracting from the first information database a data error rate corresponding to the ratio of the received signal power to the electromagnetic wave power computed for each position, and
a fourth process of outputting a region where the data error rate is above a desired data error rate in association with each position of the used area.

8. The wireless environment evaluation system according to claim 7, wherein
the first information database has stored therein a modulation scheme, a carrier frequency, an encoding scheme, data transmission/reception durations, and minimum received power of the wireless device, and dependence of the data error rate on the ratio of the received signal power to the electromagnetic noise power.

9. The wireless environment evaluation system according to 7, wherein the second information database has a frequency spectrum, a radiation angle, an electromagnetic wave generation duration, and a frequency of electromagnetic wave generations of radiated electromagnetic waves.

10. An electromagnetic noise evaluation system, wherein, in the fourth process of claim 7, the control device displays, of the used area, a region where the data error rate is above a desired data error rate on a display screen in a manner that distinguishes the region from other regions.

11. A program for causing a computer of an electromagnetic noise evaluation system, the system having or communicating with a first information database that has stored therein an operating condition and an electromagnetic wave sensing property of a first electric/electronic device, and a second information database that has stored therein radiation information on at least one second electric/electronic device that radiates electromagnetic waves, to execute:
a first process of computing propagation of electromagnetic waves radiated from the second electric/electronic device on the basis of information on a used area of the first electric/electronic device, three-dimensional position information about arrangement of the first electric/electronic device, and three-dimensional position information on the second electric/electronic device;
a second process of computing electromagnetic wave power received at each position in a three-dimensional space in which the first electric/electronic device is arranged;
a third process of extracting from the first information database a data error rate corresponding to the received electromagnetic wave power computed for each position; and
a fourth process of outputting a region where the data error rate is above a desired data error rate in association with each position of the used area.
